(19) United States
(12) Patent Application Publication
(10) Pub. No.: US 2003/0072306 A1
(43) Pub. Date: Apr. 17, 2003

(54) Network routing using position location and short-range wireless connections

(76) Inventor: Jason F. Hunzinger, Carlsbad, CA (US)

Correspondence Address: HARNESS, DICKEY & PIERCE, P.L.C., P.O. BOX 828, BLOOMFIELD HILLS, MI, 48303, US

(21) Appl. No.: 10/012,745

(22) Filed: Dec. 7, 2001

Related U.S. Application Data
(60) Provisional application No. 60/329,029, filed on Oct. 12, 2001.

(51) Int. Cl. H04L 12/28

(52) U.S. Cl. 370/389; 370/252

(57) ABSTRACT

A wireless communication network includes mobile devices which may act as sources, targets, and intermediaries for transmitted information. An intermediate nodes that receives a signal from a source intended for a target may forward the signal in the direction of the target, if the target's location is known, or transmit the signal in a direction away from the sender of the signal, e.g., the source or another intermediate node. Upon receiving the signal, the target may transmit its address and current location more aggressively in the direction of the sender, e.g., the source, if the source's location is known, or in the direction of the intermediate node from which the signal was received. The nodes may determine the locations of other nodes in the network by extracting location information from the signal or from periodically updated global location reports transmitted by a master node.

### CROSS-REFERENCE TO RELATED APPLICATION

This application claims priority to U.S. Provisional Application Serial No. 60/329,029, filed on Oct. 12, 2001.

### BACKGROUND

Wireless networks, for example, those used by mobile devices such as cellular phones and personal digital assistants (PDAs), may include a number of stationary network nodes with fixed antennas. The stationary nodes form part of the network infrastructure. The mobile devices, which may have a relatively short communication range, may communicate with a stationary node within its transmission/reception range via two-way radio frequency (RF) communication channel. The stationary node may then transmit communications signals from the mobile device to other network devices in the network infrastructure, eventually transmitting the signals to another mobile device in the network.

As the mobile device moves out of range of the stationary node, the mobile device may move into the range of another stationary node, or, if not, may be temporarily disconnected from the network.

The stationary nodes serve as the mobile devices' link to the wireless network. Since the stationary nodes are fixed in location, the overall geographic range of the wireless network may only be extended by installing additional stationary nodes. Such installations may require significant capital outlays and other costs for ascertaining and securing rights to suitable installation sites.

### SUMMARY

In an embodiment, a wireless communication network includes mobile devices which may act as sources, targets, and intermediaries for transmitted information. An intermediate node that receives a signal from a source intended for a target may forward the signal in the direction of the target, if the target's location is known, or transmit the signal in a direction away from the sender of the signal, e.g., the source or another intermediate node.

Upon receiving the signal, the target may transmit its address and current location more aggressively in the direction of the sender, e.g., the source, if the source's location is known, or in the direction of the intermediate node from which the signal was received. The nodes may determine the locations of other nodes in the network by extracting location information from the signal or from periodically updated global location reports transmitted by a master node.

### BRIEF DESCRIPTION OF THE DRAWINGS

FIG. 1 illustrates a wireless communication network according to an embodiment.

FIG. 2 is a flowchart describing a network routing operation according to an embodiment.

FIG. 3 illustrates the transmission patterns of various nodes in a network according to an embodiment.

### DETAILED DESCRIPTION

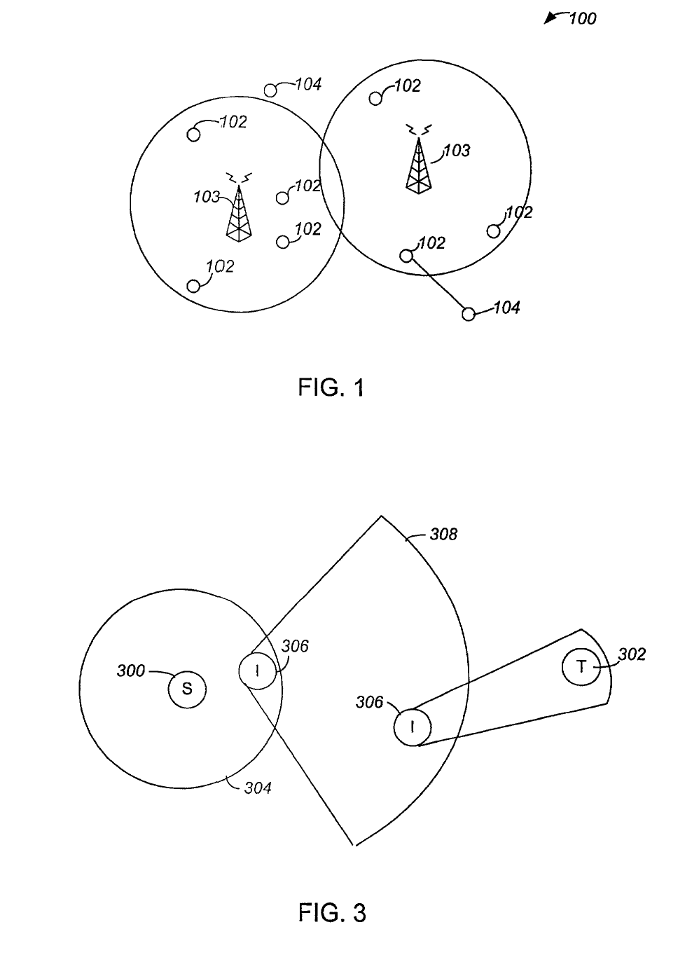

FIG. 1 illustrates a wireless communications network 100 according to an embodiment. The network 100 may include mobile nodes 102 and fixed nodes. The mobile nodes may include, for example, cellular telephones and personal digital assistants (PDAs). The nodes may connect to each other via one-to-one or broadcast transmission. The communication range of the nodes may be relatively short range. The connections may be made using one or more transmission types, for example, two-way radio frequency (RF), infrared (IR), or BlueTooth (a wireless technology and protocol for short range frequency hopping radio link between devices), or the image files may be transmitted via a digital cellular phone channel.

Each connection that makes up part of the network may be dedicated for network use, or have another primary use. For example, a user PDA device in the network may be available for transfer of traffic but the user may want to transfer an electronic business card to another PDA user. The business card transfer may take priority over any network traffic and may completely stop any unrelated activity. Similarly, other usage may have priority over resources such as memory, processing power, etc. In this sense, the network makes efficient use of unused wireless bandwidth and other resources, thereby making use of otherwise idle wireless units and resources.

The mobile devices may have a position location capability, for example, a Global Positioning System (GPS) compatible component. The mobile devices may communicate their location information along with their network address, or other identification, to other nodes in their communication range. A mobile device may use the location information it receives from other mobile devices to determine its actual location more accurately and precisely, for example, using differential GPS.

The mobile nodes may act as sources and targets for transmissions. If a target device is out of the range of a source device, the transmitted information may “hop” to one or more intermediate nodes before reaching the target. Other mobile nodes in the network, as well as the fixed nodes, may serve as intermediate nodes for forwarding network traffic.

Over time, the physical position of the nodes in the network may change, possibly placing some nodes 104 out of range of the network or out of range of some nodes but into range of other nodes. Also, the wireless link conditions may change over time such that the connections used to connect a source to a target may change. In either case, transmissions from source to destination can be made more efficient by directing the traffic according to the physical position of the source nodes, destination nodes, and any intermediate nodes. In an embodiment, the mobile and fixed nodes may have directional transmission capabilities. For example, the nodes may include directional antennas which direct signals in desired directions or ranges of directions. Alternatively, or in addition, the nodes may store the addresses of nodes along with location information corresponding to each address. The nodes may broadcast a signal specifically addressed to nodes in locations corresponding to a desired direction or range of directions. The nodes may use the location information received from mobile nodes in their vicinity together with their own location information to direct network traffic.

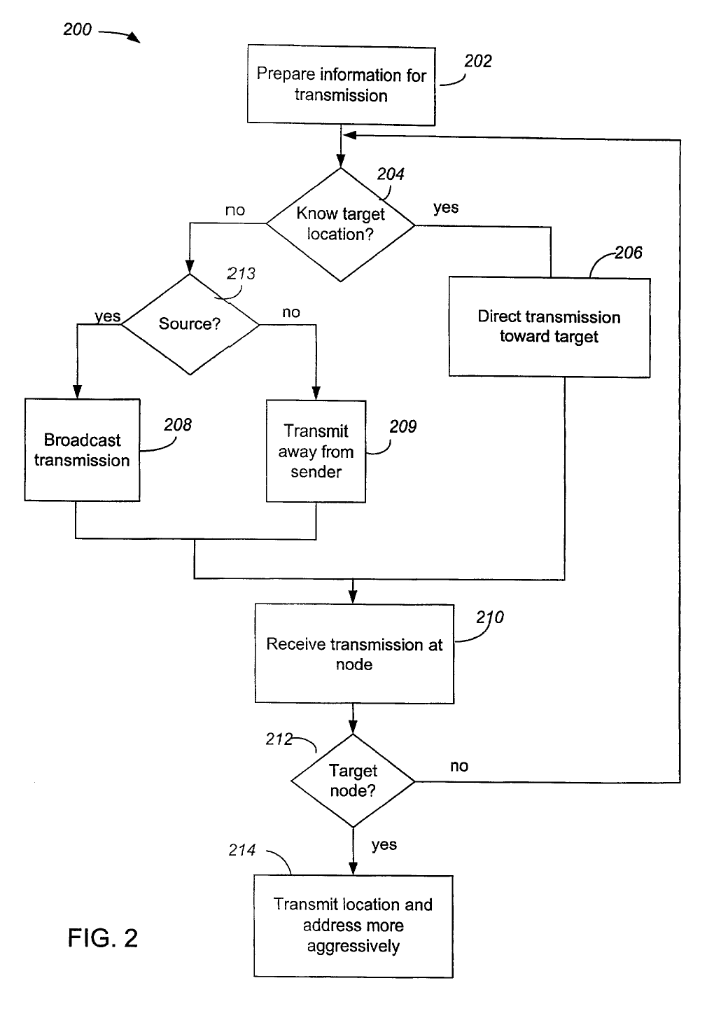

FIG. 2 is a flowchart describing a network routing operation 200 according to an embodiment. A source node 300 prepares information intended for a target node 302 for transmission (block 202), as shown in FIG. 3. Preparing the information for transmission may include formatting the data into packets, or other type of data segments, and including the target address in the outgoing packets. If the source node 300 knows the location of the target node 302 (block 204), the source node may use its own location information to determine the direction of the target node from the source node's location, and transmit the information in the direction of the target node (block 206). If the target does not know the location of the target node, the source node may broadcast the information in all directions 304 (block 208).

One or more nodes within range of the source node 302 may receive the transmission (block 210). If the receiving node is not the target node (block 212), i.e., an intermediate node 306 (block 213), it is determined whether the node knows the location of the target (block 204). If so, the intermediate node 306 may direct the transmission to the last known location of the target (block 206). If the intermediate node does not know the location of the target, the intermediate node may transmit the information in a range of directions 308 away from the sender of the information (block 209). The sender may be the source node, or another intermediate node. A transmission from the source node 300 to the intermediate node 306 constitutes one hop in the connection between the source node and the target node 302.

Once the target node receives the information, or some indication that it is the target of a transmission, the target node 302 may begin to transmit its location information more aggressively (block 214). For example, the target node may update and transmit its location more frequently. The target node may aloes increase the power at which it transmits its location information to improve the signal quality and/or range of the transmission. The target node may also transmit packets including its location information in the direction of the source, if known. To facilitate this, the source node 300 include its location information in the transmission. If the location of the source node is not known, the target node may broadcast its location information, or direct transmission of its location in the direction of the intermediate node from which it received the transmission originating from the source.

The component nodes in such a mobile wireless network may change over time. Mobile nodes may move out of range of the network, or out of range of some nodes and into range of other nodes. The wireless link conditions may change, causing the network connections to change. Also, some nodes may not be available for directing traffic as they perform higher priority functions (for example, the PDA e-business card transfer described above) or may be turned off. Local “master” nodes may be designated to account for and track the availability of mobile nodes in a portion of the network. The master nodes may be designated in a real-time fashion, and may change rapidly depending on the physical movement of the mobile nodes. Mobile units may update other units on their location on a periodic basis, whenever their position changes significantly, and/or whenever they come into range or contact with new units. The master node collects location information and location updates from non-master nodes in its range and any nearby master nodes. In the case of BlueTooth wireless connections, the master nodes can be BlueTooth master nodes.

The mobile devices may be able to determine their velocity and/or direction of travel in addition to position location. The nodes may include this information in their transmission, e.g., location updates and headers in packets for transmissions from source nodes. This velocity information may be used to determine and alter connections. Nodes may direct transmission so that the information may travel closer to the target in the near future (block 206). For example, on a road or highway, a transmission may be directed to a unit traveling in the opposite direction if the target node is in that direction. The transmissions including velocity and/or direction information may also include a time stamp for use in extrapolating location into the future as a result of the velocity and/or direction.

The nodes may transmit the address and location information of a newly detected neighbor to other nodes in the network. The node may periodically broadcast a request to identify other nodes in its vicinity. For example, a Bluetooth-enabled node may broadcast an “inquiry” signal. Other Bluetooth-enabled nodes in that receive the inquiry may respond with their address, capabilities, and location information. The requesting node may then broadcast this information to other nodes in the network.

The techniques described here may be implemented in hardware or software, or a combination of the two. The techniques may be implemented in computer programs executed on one or more programmable computers that may each includes a processor, a storage medium readable by the processor (including volatile and non-volatile memory and/or storage elements), and suitable input and output devices. The programmable computers may be either general-purpose computers or special-purpose, embedded systems.

A number of embodiments of the present invention have been described. Nevertheless, it will be understood that various modifications may be made without departing from the spirit and scope of the invention. For example, blocks in the flowcharts used to describe the various operations may be skipped or performed in a different order and produce desirable results. Accordingly, other embodiments are within the scope of the following claims.

1. A method for forwarding a signal from a first node to a second node comprising:
receiving a signal intended for the second node at the first node, said signal including address information identifying said second node;
extracting the address information from the signal;
attempting to determine a location of the second node;
transmitting the signal to the second node in response to determining the location of the second node; and
determining a direction from which the signal was received and transmitting the signal away from said direction in response to not determining the location of the second node.

2. The method of claim 1, wherein the received signal includes information indicative of the location of the second node.

3. The method of claim 1, wherein said transmitting the signal to the second node comprises:
determining a current location of the first node; and
determining a direction from the current location to the location of the second node; and
transmitting the signal in said direction.

4. The method of claim 1, further comprising receiving a first location report from a node, said report including addresses for a plurality of nodes and location information associated with a plurality of said addresses.

5. The method of claim 4, further comprising receiving a second location report from the node, said report including updated location information associated with at least one of said addresses.

6. The method of claim 1, wherein said transmitting the signal to the second node comprises transmitting the signal in a general direction of the second node, said direction including the determined location of the second node.

7. The method of claim 1, wherein the received signal includes information indicative of a dynamic quality of the second node.

8. The method of claim 7, wherein the information indicative of the dynamic quality includes a velocity of the second node.

9. The method of claim 7, wherein the information indicative of the dynamic quality includes a direction of travel of the second node.

10. The method of claim 7, further comprising determining a predictive future location of the second node from the information indicative of the dynamic quality of the second node; and
transmitting the signal to the predictive future location.

11. The method of claim 3, wherein said transmitting the signal in said direction comprises limiting a transmission of the signal in other directions.

12. The method of claim 1, wherein the received signal includes information indicative of the location of the sender of the signal.

13. The method of claim 1, wherein said determining the direction from which the signal was received comprises:
extracting the sender's location from the signal; and
computing the direction from said sender's location to said first node.

14. A method comprising:
receiving a signal as an intended target;
determining a current location;
transmitting a location report including identification information and location information indicative of the current location to a sender of the signal; and
transmitting the location report at a transmit power level.

15. The method of claim 14, wherein said transmitting the location report to the sender comprises:
determining a direction in which the signal was received; and
transmitting the location report in said direction.

16. The method of claim 14, further comprising transmitting the location report at an increased transmit power level in response to receiving a signal as an intended target.

17. The method of claim 14, further comprising transmitting the location report repeatedly with a greater frequency in response to receiving a signal as an intended target.

18. The method of claim 14, further comprising:
determining the location of the sender; and
determining the direction of the sender from the location of the sender and the current location.

19. The method of claim 18, wherein the sender is a source of the signal.

20. The method of claim 18, wherein determining the location of the sender comprises extracting information indicative of the sender's location from the signal.

21. The method of claim 18, wherein determining the location of the sender comprises:
receiving a first global location report from a node, said report including addresses for a plurality of nodes and location information associated with a plurality of said addresses;
extracting an address of the sender from the signal; and
comparing said sender address to the addresses in the first global location report.

22. The method of claim 21, further comprising receiving a second global location report from the node, said report including updated location information associated with at least one of said addresses.

23. The method of claim 14, wherein the location report further include information indicative of a dynamic quality of the node.

24. The method of claim 23, wherein the information indicative of the dynamic quality includes a velocity of the node.

25. The method of claim 23, wherein the information indicative of the dynamic quality includes a direction of travel of the node.

26. The method of claim 14, further comprising updating the location report in response to a change in the current location.

27. The method of claim 14, further comprising updating the location report in response to a change in the dynamic quality of the node.

28. The method of claim 14, further comprising:
broadcasting a location request;
receiving an address and information indicative of a location for a neighboring node; and
broadcasting the address and information indicative of the location of the neighboring node.

29. The method of claim 14, further comprising updating the location report in response to coming into contact with new nodes or losing contact with old nodes.

30. The method of claim 14, wherein said transmitting the location report comprises transmitting the location report repeatedly at the transmit power level.

31. An apparatus comprising:
an antenna operative to receive and transmit wireless communication signals;
an antenna controller operative to determine a direction of received signals and to transmit signals in a selected direction or range of directions;
a memory device operative to store address information and location information associated with a plurality of nodes; and
a routing controller operative to
receive a signal intended for a node, said signal including address information identifying said node,
extract the address information from the signal,
attempt to determine a location of the node,
transmit the signal to the node in response to determining the location of the node, and
determine a direction from which the signal was received and transmitting the signal away from said direction in response to not determining the location of the node.

32. The apparatus of claim 31, wherein the received signal includes information indicative of the location of the node, and wherein determining the location of the node comprises extracting the location information from the signal.

33. The apparatus of claim 31, wherein the routing controller is further operative to:
determine a current location of the apparatus; and
determine a direction from the current location to the location of the node; and
transmit the signal in said direction.

34. The apparatus of claim 33, wherein the memory device is further operative to store a first location report received from a master node, said report including addresses for a plurality of nodes and location information associated with a plurality of said addresses.

35. The apparatus of claim 34, wherein the memory device is further operative to update the information in the stored address and location information in response to receiving a second location report from the master node, said report including updated location information associated with at least one of said addresses.

36. An apparatus comprising:
an antenna operative to receive and transmit wireless communication signals;
an antenna controller operative to determine a direction of received signals and to transmit signals in a selected direction or range of directions;
a memory device operative to store address information and location information associated with a plurality of nodes; and
a routing controller operative to
receive a signal as an intended target;
determine a current location of the apparatus; and
transmit a location report including
identification information and location information indicative of the current location to a sender of the signal.

37. The apparatus of claim 36, wherein the routing controller is further operative to transmit the location report repeatedly at a transmit power level.

38. The apparatus of claim 37, wherein the routing controller is further operative to transmit the location report at an increased transmit power level in response to receiving a signal as an intended target.

39. The apparatus of claim 38, wherein the routing controller is further operative to transmit the location report repeatedly with a greater frequency in response to receiving a signal as an intended target.

40. The apparatus of claim 37, wherein the routing controller is further operative to:
determine the location of the sender; and
determine the direction of the sender from the location of the sender and the current location.

41. An article comprising a machine-readable medium which stores machine-executable instructions, said instructions operative to cause the machine to:
receive a signal intended for a node, said signal including address information identifying said node;
extract the address information from the signal;
attempt to determine a location of the node;
transmit the signal to the node in response to determining the location of the node; and
determine a direction from which the signal was received and transmitting the signal away from said direction in response to not determining the location of the node.

42. The article of claim 41, wherein the received signal includes information indicative of the location of the node.

43. An article comprising a machine-readable medium which stores machine-executable instructions, said instructions operative to cause the machine to:
receive a signal as an intended target;
determine a current location;
transmit a location report including identification information and location information indicative of the current location to a sender of the signal; and
transmit the location report repeatedly.

44. The article of claim 43, wherein the instructions operative to cause the machine to transmit the location report to the sender further comprise instructions operative to cause the machine to:
determine a direction in which the signal was received; and
transmit the location report in said direction.
